(19) United States
(12) Patent Application Publication
(10) Pub. No.: US 2015/0127722 A1
(43) Pub. Date: May 7, 2015

(54) DATA PROCESSING METHOD, APPARATUS AND SYSTEM

(71) Applicant: TENCENT TECHNOLOGY (SHENZHEN) COMPANY LIMITED, Shenzhen (CN)

(72) Inventor: CHAO FENG, Shenzhen (CN)

(73) Assignee: TENCENT TECHNOLOGY (SHENZHEN) COMPANY LIMITED

(21) Appl. No.: 14/591,264

(22) Filed: Jan. 7, 2015

Related U.S. Application Data
(63) Continuation of application No. PCT/CN2014/077640, filed on May 16, 2014.

(30) Foreign Application Priority Data
Oct. 22, 2013 (CN) 2013-10499540.4

(51) Int. Cl. H04L 29/08; H04L 29/06

(52) U.S. Cl. CPC H04L 67/2823; H04L 67/42
USPC 709/203

(57) ABSTRACT

A data processing method applied to a proxy capable of communicating with a client and a server is provided. The method includes the proxy receiving request data in a first data format sent from the client associated with a computer game, where the first data format of the request data is supported by the client. The method also includes the proxy converting the first data format of the request data into a specific data format associated with the server and not supported by the client, where the specific data format is a binary data format and used by the server. Further, the method includes the proxy sending the request data in the specific data format to the server, such that the server can process the request data in the specific data format.

### CROSS-REFERENCES TO RELATED APPLICATIONS

This application is a continuation application of PCT Patent Application No. PCT/CN2014/077640, filed on May 16, 2014, which claims priority of Chinese Patent Application No. 201310499540.4, filed on Oct. 22, 2013, the entire contents of which are incorporated by reference herein.

### FIELD OF THE INVENTION

The present invention generally relates network communication technologies and, more particularly, to methods, apparatuses and systems for data processing.

### BACKGROUND

A Client/Server (C/S) system is a client and server system architecture. A client program runs on a client and sends request data to a server program running on a server. After the server program processes the request data, the server program returns feedback data to the client.

The Client/Server (C/S) system is often used in some particular network data communication fields, such as real-time games. Currently, because there are limitations on data formats of the server data communication, when processing data, a specific data communication format is usually used for data transmitted between the server and the client. That is, when the client sends the request data to the server, the format of the request data must be a specific data format that is supported by the server. After the server receives the request data, the server also returns the feedback data in the specific data format. There are strict formatting requirements for the data transmitted between the client and the server.

For example, in some particular network data communication fields, a socket connection is usually used as a communications protocol between a server and a client. Because the socket connection is based on a Transmission Control Protocol (TCP) connection, binary data needs to be transmitted and the server needs to support the data in a binary data format. Therefore, the data transmitted between the server and the client must be the data in the binary data format. This requires that the client that participates in data processing can support the data in the binary data format.

However, for such conventional techniques, when processing data between the server and the client, a specific data communication format is usually used to transmit data between the server and the client. Therefore, the system requirements for the client are relatively high. However, due to the diversity of the clients, not all clients can support the specific data format, causing poor compatibility of the server for different clients.

The disclosed method and apparatus are directed to solve one or more problems set forth above and other problems.

### BRIEF SUMMARY OF THE DISCLOSURE

One aspect of the present disclosure includes a data processing method applied to a proxy capable of communicating with a client and a server. The method includes the proxy receiving request data in a first data format sent from the client associated with a computer game, where the first data format of the request data is supported by the client. The method also includes the proxy converting the first data format of the request data into a specific data format associated with the server and not supported by the client, where the specific data format is a binary data format and used by the server. Further, the method includes the proxy sending the request data in the specific data format to the server, such that the server can process the request data in the specific data format. The method includes the proxy receiving feedback data in the specific data format sent from a server, where the specific data format is the binary data format. The method also includes the proxy converting the specific data format of the feedback data into a data format that is supported by the client. The method includes the proxy sending the feedback data in the converted data format to the client.

Another aspect of the present disclosure includes a data processing apparatus applied to a proxy capable of communicating with a client and a server. The apparatus includes a first receiving module configured to receive request data in a first data format sent from the client associated with a computer game, where the first data format of the request data is supported by the client. The apparatus also includes a first data format conversion module configured to convert the first data format of the request data into a specific data format associated with the server and not supported by the client, where the specific data format is a binary data format and used by the server. Further, the apparatus includes a first sending module configured to send the request data in the specific data format to the server, such that the server processes the request data in the specific data format. The apparatus includes a second receiving module configured to receive feedback data in the specific data format sent from the server, where the specific data format is the binary data format. The apparatus also includes a second data format conversion module configured to convert the specific data format of the feedback data into a data format that is supported by the client. The apparatus includes a second sending module configured to send the feedback data in the converted data format to the client.

Another aspect of the present disclosure includes a data processing system. The system includes a client configured to send request data to a proxy and receive feedback data in the converted data format sent from the proxy. The system also includes the proxy configured to receive the request data in a first data format sent from the client associated with a computer game, convert the first data format of the request data into a specific data format associated with a server and not supported by the client, and send the request data in the specific data format to the server. The system includes the proxy further configured to receive the feedback data in the specific data format sent from the server, convert the data format of the feedback data into a data format that is supported by the client and send the feedback data in the converted data format to the client. Further, the system includes the server configured to receive the request data in the specific data format sent from the proxy, process the request data in the specific data format, and send the feedback data in the specific data format to the proxy.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 shows a flow chart of an exemplary data processing process consistent with the disclosed embodiments;

FIG. 2 shows a flow chart of another exemplary data processing process consistent with the disclosed embodiments;

FIG. 3 shows a structure diagram of an exemplary data processing apparatus consistent with the disclosed embodiments;

FIG. 4 shows a structure diagram of an exemplary first receiving module consistent with the disclosed embodiments;

FIG. 5 shows a structure diagram of an exemplary first data format conversion module consistent with the disclosed embodiments;

FIG. 6 shows a flow chart of another exemplary data processing process consistent with the disclosed embodiments;

FIG. 7 shows a flow chart of another exemplary data processing process consistent with the disclosed embodiments;

FIG. 8 shows a structure diagram of another exemplary data processing apparatus consistent with the disclosed embodiments;

FIG. 9 shows a structure diagram of an exemplary second receiving module consistent with the disclosed embodiments;

FIG. 10 shows a structure diagram of an exemplary second data format conversion module consistent with the disclosed embodiments;

FIG. 11 shows a flow chart of another exemplary data processing process consistent with the disclosed embodiments;

FIG. 12 shows a structure diagram of an exemplary data processing system consistent with the disclosed embodiments;

FIG. 13 shows a structure diagram of an exemplary electronic equipment consistent with the disclosed embodiments; and

FIG. 14 shows a structure diagram of another exemplary data processing system consistent with the disclosed embodiments.

### DETAILED DESCRIPTION

In order to explain the objectives, technical solutions and advantages of the present invention more clearly, the embodiments of the present invention will be further described in detail below in conjunction with the drawings.

Compared to a traditional client/server (C/S) system, a single-tiered proxy is added in the client/server system of the present disclosure. The proxy can communicate data between a client and a server, respectively. The data processing process provided in the present disclosure is applied to the proxy. FIG. 1 shows a flow chart of an exemplary data processing process. As shown in FIG. 1, the process may include the following steps.

S100: a proxy receives request data sent from a client. A data format of the request data can be any format that is supported by the client.

S110: the proxy converts the data format of the request data into a specific data format. The specific data format can be any format that is supported by a server.

S120: the proxy sends the request data in the specific data format to the server, such that the server can process the request data in the specific data format.

In the data processing process, a single-tiered proxy is added between the client and the server. The proxy is used as a data communication bridge between the client and the server. The proxy receives the request data sent from the client and converts the data format of the request data into a specific data format. Then, the proxy sends the request data in the specific data format to the server, such that the server can process the request data from various clients. Thus, the server is compatible with different clients in data processing between the client and the server, improving the compatibility of the server for different clients.

Optionally, socket communication can be used between the client and the server. The proxy may be a socket proxy. Correspondingly, under the socket communication mechanism, the specific data format that is supported by the server may be a binary data format; the data format of the request data sent from the client can be any format (e.g., text format).

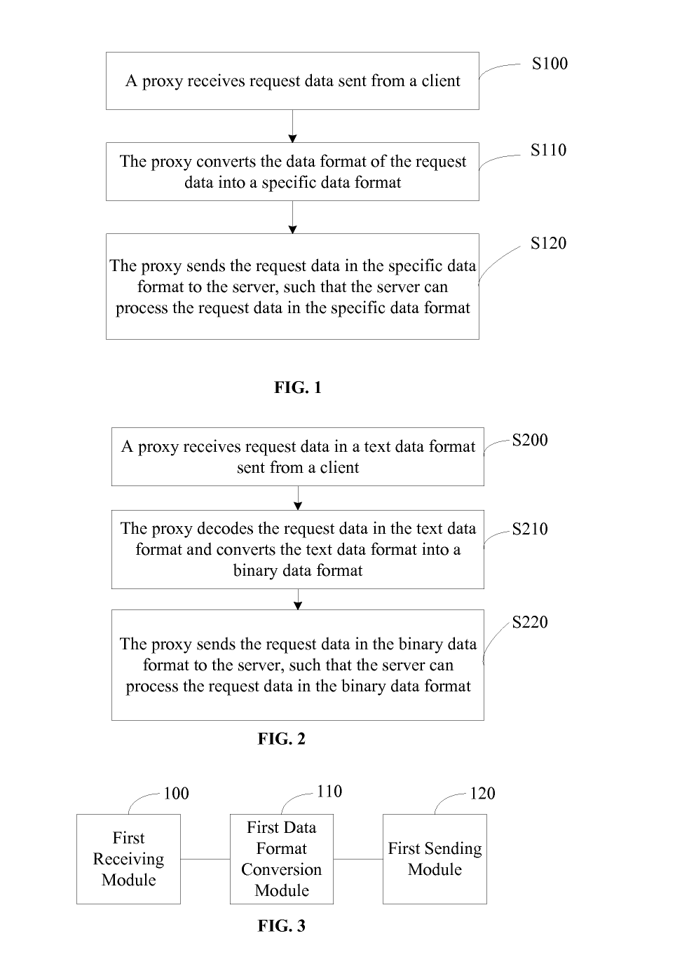

FIG. 2 shows a flow chart of another exemplary data processing process. As shown in FIG. 2, the process may include the following steps.

S200: a proxy receives request data in a text data format sent from a client.

S210: the proxy decodes the request data in the text data format and converts the text data format into a binary data format.

Optionally, the proxy decodes request data in a text data format to request data in a binary data format by a base64 decoding scheme. The base64 decoding scheme is a text-to-binary decoding scheme. Computers store all characters as numbers stored as binary data. Binary code uses the digits of 0 and 1 (binary numbers) to represent computer instructions or text. Each instruction or symbol gets a bit string assignment. The strings can correspond to instructions, letters, or symbols.

S220: the proxy sends the request data in the binary data format to the server, such that the server can process the request data in the binary data format.

Optionally, the client can be a browser client. Correspondingly, the proxy can be a WebSocket proxy. For example, the client is a HTML5 browser client. The WebSocket proxy can be added on a network module of the HTML5 browser so as to decode the request data sent from the client and convert the data format of the request data into a specific data format.

Optionally, by using the data processing process provided in the present disclosure, all data requests between the client and the server can be completed, including a handshake authentication process between the client and the server.

In the data processing process, a single-tiered proxy that converts a data format is added between the client and the server. The proxy receives the request data sent from the client and converts the data format of the request data into a specific data format that is supported by the server. Then, the proxy sends the request data in the specific data format to the server. Thus, the server is compatible with different clients in data processing between the client and the server, improving the compatibility of the server for different clients.

FIG. 3 shows a structure diagram of an exemplary data processing apparatus. The data processing apparatus may apply to a proxy that can communicate data between a client and a server, respectively. As shown in FIG. 3, the apparatus may include a first receiving module 100, a first data format conversion module 110, and a first sending module 120.

The first receiving module 100 is configured to receive request data sent from the client. A data format of the request data can be any format that is supported by the client.

The first data format conversion module 110 is configured to convert the data format of the request data into a specific data format. The specific data format can be any format that is supported by the server.

The first sending module 120 is configured to send the request data in the specific data format to the server, such that the server can process the request data into the specific data format.

Optionally, socket communication can be used between the client and the server. The proxy may be a socket proxy. If the client is a browser client, correspondingly, the proxy can be a WebSocket proxy. Correspondingly, under the socket communication mechanism, the specific data format that can be supported by the server may be a binary data format; the data format of the request data sent from the client can be any format (e.g., text format).

FIG. 4 shows a structure diagram of an exemplary first receiving module 100. As shown in FIG. 4, the first receiving module 100 may include a first receiving unit 101. The first receiving unit 101 is configured to receive request data in a text format sent from a client.

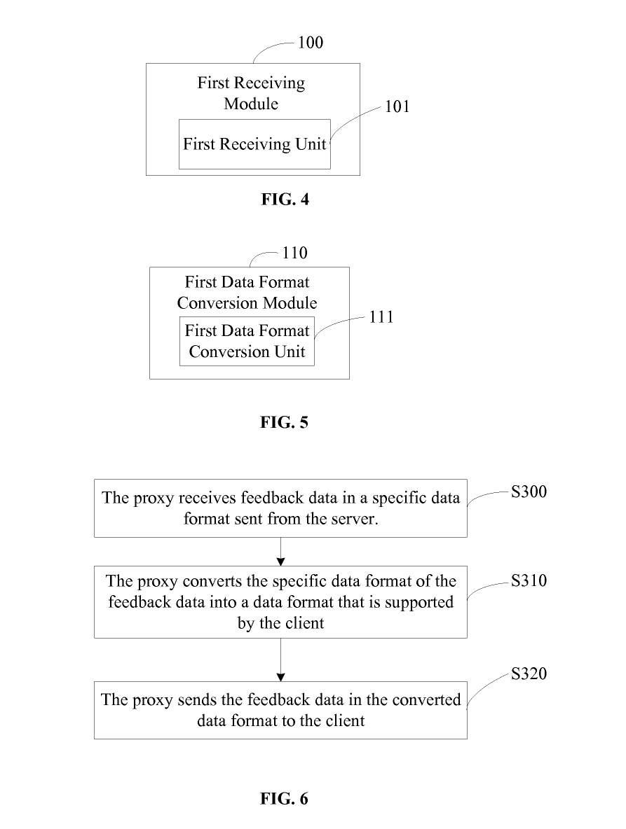

FIG. 5 shows a structure diagram of an exemplary first data format conversion module 110. As shown in FIG. 5, the first data format conversion module 110 may include a first data format conversion unit 111. The first data format conversion unit 111 is configured to decode the request data in a text data format and convert the text data format into a binary data format.

Optionally, the proxy decodes the request data in the text data format by a base64 decoding scheme.

In the data processing apparatus, a single-tiered proxy is added between the client and the server. The proxy is used as a data communication bridge between the client and the server. The proxy receives the request data sent from the client and converts the data format of the request data into a specific data format. Then, the proxy sends the request data in the specific data format to the server, such that the server can process the request data from various clients.

Thus, the server is compatible with different clients in data processing between the client and the server, improving the compatibility of the server for different clients.

FIG. 6 shows a flow chart of another exemplary data processing process. The data processing process may be applied to a proxy that can communicate data between a client and a server, respectively. As shown in FIG. 6, the process may include the following steps.

S300: the proxy receives feedback data in a specific data format sent from the server.

When a proxy receives request data sent from a client, the proxy converts the data format of the request data into the specific data format and sends the request data in the specific data format to the server. The server processes the request data in the specific data format and acquires the feedback data. The proxy may receive the feedback data in the specific data format sent from the server.

The specific data format of the request data can be any format that is supported by the server.

S310: the proxy converts the specific data format of the feedback data into a data format that is supported by the client.

S320: the proxy sends the feedback data in the converted data format to the client.

In the data processing process, a single-tiered proxy is added between the client and the server. The proxy is used as a data communication bridge between the client and the server. The proxy receives feedback data in a specific data format sent from the server and converts the data format of the feedback data into a data format that is supported by the client. Then, the proxy sends the feedback data to the client, such that the client can directly process the feedback data. Thus, the server's compatibility with different clients in the data processing between the client and the server is improved.

Optionally, socket communication can be used between the client and the server. The proxy may be a socket proxy. Correspondingly, under the socket communication mechanism, the specific data format that is supported by the server may be a binary data format; the data format of the request data sent from the client can be any format (e.g., text format).

FIG. 7 shows a flow chart of another exemplary data processing process. As shown in FIG. 7, the process may include the following steps.

S400: a proxy receives feedback data in a binary data format sent from a server.

S410: the proxy encodes the feedback data in the binary data format and converts the binary data format of the feedback data to a text data format.

Optionally, the proxy encodes the binary data format of the feedback data by a base64 encoding method.

S420: the proxy sends the feedback data in the text data format to the client, such that the client can directly process the feedback data.

Optionally, all data feedbacks between the client and the server can be completed by using the data processing process, including a handshake authentication process between the client and the server.

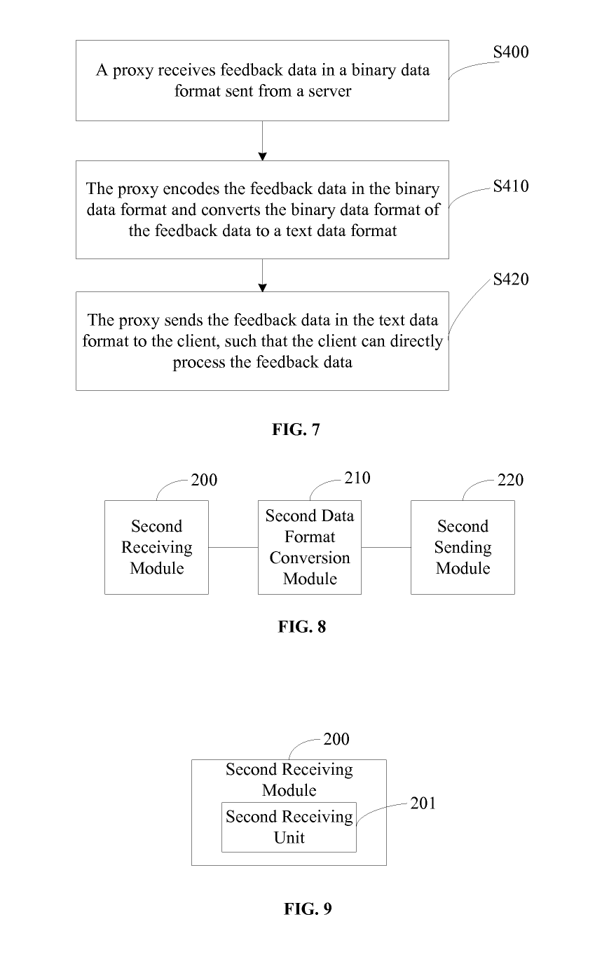

FIG. 8 shows a structure diagram of another exemplary data processing apparatus. The data processing apparatus may apply to a proxy that can communicate data between a client and a server, respectively. As shown in FIG. 8, the data processing apparatus may include a second receiving module 200, a second data format conversion module 210, and a second sending module 220.

The second receiving module 200 is configured to receive feedback data in a specific data format sent from the server.

The second data format conversion module 210 is configured to convert the specific data format of the feedback data into a data format that is supported by the client.

The second sending module 220 is configured to send the feedback data in the converted format to the client.

Optionally, socket communication can be used between the client and the server. The proxy may be a socket proxy. If the client is a browser client, correspondingly, the proxy can be a WebSocket proxy. Correspondingly, under the socket communication mechanism, the specific data format that is supported by the server may be a binary data format; the data format of the request data sent from the client can be any format (e.g., text format).

FIG. 9 shows a structure diagram of an exemplary second receiving module 200. As shown in FIG. 9, the second receiving module 200 may include a second receiving unit 201. The second receiving unit 201 is configured to receive feedback data in a binary data format sent from a server.

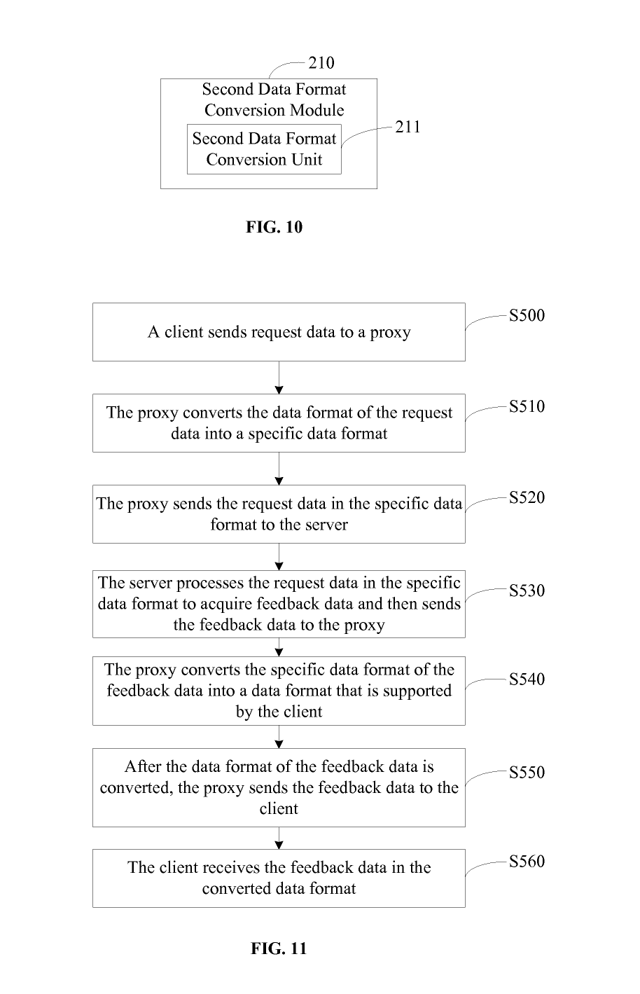

FIG. 10 shows a structure diagram of an exemplary second data format conversion module 210. As shown in FIG. 10, the second data format conversion module 210 may include a second data format conversion unit 211. The second data format conversion unit 211 is configured to encode the feedback data in the binary data format and convert the binary data format of the feedback data into a text data format.

In the data processing apparatus, a single-tiered proxy is added between the client and the server. The proxy receives feedback data in a specific data format sent from the server and converts the data format of the feedback data into a data format that is supported by the client. Then, the proxy sends the feedback data to the client, such that the client can directly process the feedback data. Thus, the server's compatibility with different clients in the data processing between the client and the server is improved.

FIG. 11 shows a flow chart of another exemplary data processing process. As shown in FIG. 11, the process may include the following steps.

S500: a client sends request data to a proxy. Optionally, the client may be a browser client. For example, the client is a HTML5 browser client.

Optionally, the format of the request data may be a text data format. The client may encode the request data to the text data format by a base64 encoding scheme. The base64 encoding scheme represents binary data in an ASCII string format by translating the binary data into a radix-64 representation. Then, the client sends the request data in the text data format to the proxy.

S510: the proxy converts the data format of the request data into a specific data format. Optionally, the proxy may be a WebSocket proxy. The specific data format may be a binary data format.

Optionally, when the data format of the request data is a text data format, the request data in the text data format may be decoded to the request data in a binary data format by a base64 decoding scheme.

S520: the proxy sends the request data in the specific data format to the server.

S530: the server processes the request data in the specific data format to acquire feedback data and then sends the feedback data to the proxy.

S540: the proxy converts the specific data format of the feedback data into a data format that is supported by the client.

Optionally, the data format that is supported by the client may be a text data format.

S550: after the data format of the feedback data is converted, the proxy sends the feedback data to the client.

S560: the client receives the feedback data in the converted data format.

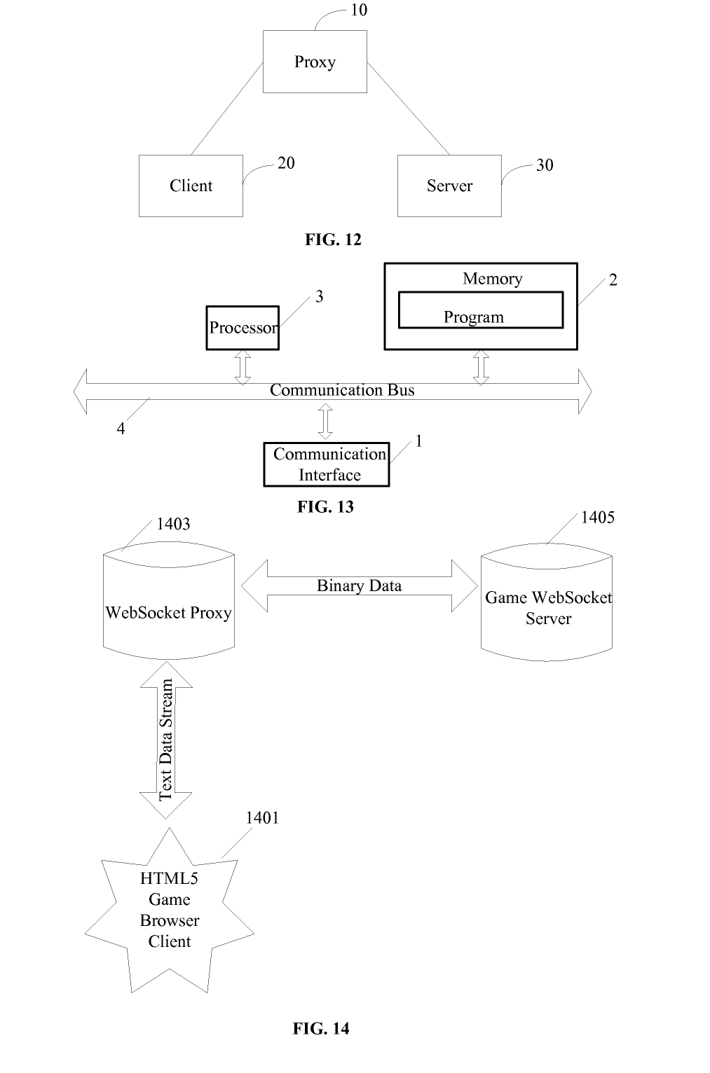

FIG. 12 shows a structure diagram of an exemplary data processing system. As shown in FIG. 12, the data processing system may include a proxy 10, a client 20 and a server 30.

Compared to a traditional client/server (C/S) system, the proxy 10 that communicates respectively data between the client 20 and server 30 is added in the client/server system of the present disclosure.

The client 20 is configured to send request data to the proxy 10 and receive feedback data in the converted data format sent from the proxy 10.

The proxy 10 is configured to receive the request data sent from the client 20. The proxy 10 is also configured to convert the data format of the request data into a specific data format and send the request data in the specific data format to the server 30. Further, the proxy 10 is configured to receive the feedback data in a specific data format sent from the server 30, convert the data format of the feedback data into a data format that is supported by the client 20, and send the feedback data in the converted data format to the client 20.

The server 30 is configured to receive the request data in the specific data format sent from the proxy 10, process the request data in the specific data format, and send the feedback data in the specific data format to the proxy 10.

FIG. 14 shows a structure diagram of another exemplary data processing system. As shown in FIG. 14, the data processing system includes a HTML5 game browser client 1401, a game WebSocket server 1405, and a WebSocket proxy 1403.

The WebSocket proxy 1403 is added between the HTML5 game browser client 1401 and the game WebSocket server 1405. WebSocket is a protocol providing full-duplex communications channels over a single TCP connection. WebSocket is designed to be implemented in web browsers and web servers, but it can be used by any client or server application. To establish a WebSocket connection, the HTML5 game browser client 1401 sends a WebSocket handshake request, and the game WebSocket server 1405 sends a WebSocket handshake response.

Once the connection is established, the HTML5 game browser client 1401 may encode the request data to a text data format by a base64 encoding scheme. The WebSocket proxy 1403 decodes the request data sent from the HTML5 game browser client 1401 and converts the text data format of the request data into a binary data format using a base64 decoding scheme. The WebSocket proxy 1403 sends the request data in the binary data format to the game WebSocket server 1405, such that the game WebSocket server 1405 can process the request data. The game WebSocket server 1405 then sends feedback data in the binary data format to the WebSocket proxy 1403. The WebSocket proxy 1403 encodes the feedback data sent from the game Web Socket server 1405 and converts the binary data format of the request data into the text data format. The WebSocket proxy 1403 sends the feedback data in the text data format to the HTML5 game browser client 1401. Thus, the current game server may support HTML5 games without changing the current game server.

It should be noted that other binary-to-text encoding/decoding methods (e.g., base16, base 32, Intel HEX, uuencoding, etc.) can be also used as a mechanism for the data processing system.

FIG. 13 shows a structure diagram of an exemplary electronic equipment of a proxy. As shown in FIG. 13, the electronic equipment may include a communication interface 1, a memory 2, a processor (or “processing unit”) 3, and a communication bus 4. Certain devices may be omitted and other devices may be included.

The communication interface 1 is configured to receive and send signals in receiving and sending between the electronic equipment and peripheral equipment process. The communication interface 1 may be an interface of a communication module, such as an interface of a network card.

The communication interface 1 may include wired communication port(s) and/or wireless transmission and reception circuitry. The wired communication port(s) receive and send communication signals via one or more wired interfaces, e.g., Ethernet, Universal Serial Bus (USB), FIREWIRE, etc. The wireless circuitry receives and sends Radio Frequency (RF) signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol The communication interface 1 enables communication between the electronic equipment with networks, such as the Internet, an intranet and/or a wireless network, such as a cellular telephone network, a wireless local area network (LAN) and/or a metropolitan area network (MAN), and other devices.

The memory 2 is configured to store software programs, modules, instructions, and data structures. The one or more processors 3 are coupled to the memory 2 and operable to execute these programs, modules, and instructions, and read/write from/to the data structures stored in the memory 2 for implementing various functions of the electronic equipment. The memory 2 includes a memory program area and a memory data area. The memory program area stores operating systems, applications (such as sound playback, image playback, etc.), and so on. For example, an operating system includes various software components and/or drivers for controlling and managing general system tasks (e.g., memory management, storage device control, power management, etc.) and facilitates communications between various hardware, firmware, and software components. The memory data area stores data used by the electronic equipment (such as audio data, video data, phone book, etc.).

The memory 2 may include high-speed random access memory (RAM), such as DRAM, SRAM, or other random access solid state memory devices. The memory 2 may also include non-volatile memory, such as one or more magnetic disk storage devices, optical disk storage devices, flash memory devices, or other non-volatile solid state storage devices.

The processor 3 is a control center of the electronic equipment, which connects various parts of the electronic equipment using a variety of interfaces and circuits. The processor 3 performs various functions and processes data by running or executing a software program and/or modules stored in the memory 2, and calling data stored in the memory 2, thus monitoring the overall electronic equipment. Processor 3 may include any appropriate processor or processors. Further, processor 3 can include multiple cores for multi-thread or parallel processing. The processor may be General Processor, central processing unit (CPU), Microprogrammed Control Unit (MCU), digital signal processor (DSP), graphics processing unit (GPU), system on a chip (SOC), application specific integrated circuits (ASIC), etc.

The communication interface 1, the memory 2, the processing unit 3 communicate with one another over one or more communication buses 4.

When the processor 3 receives request data sent from the client via the communication interface 1, the processor 3 converts the data format of the request data into a specific data format and sends the request data in the specific data format to the server via the communication interface 1. The server processes the request data in the specific data format.

The processor 3 receives the feedback data in the specific data format sent from the server via the communication interface 1. The processor 3 converts the specific data format of the feedback data into a data format that is supported by the client and sends the feedback data in the converted data format to the client.

The electronic equipment may have more or fewer components than shown, may combine two or more components, or may have a different configuration or arrangement of the components.

A single-tiered proxy that converts a data format is added between the client and the server. The proxy receives the request data sent from the client and converts the data format of the request data into a specific data format that is supported by the server. Further, the proxy may convert the data format of the feedback data sent from the server into a data format that is supported by the client. Thus, the server is compatible with different clients in data processing between the client and the server, improving the compatibility of the server for different clients.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those of skill would further appreciate that the various illustrative modules and algorithm steps described in connection with the embodiments disclosed herein may be implemented as electronic hardware, computer software, or combinations of both. To clearly illustrate this interchangeability of hardware and software, various illustrative modules and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed data processing methods and apparatus applied to a proxy capable of communicating with a client and a server, the proxy is used as a data communication bridge between the client and the server. The proxy receives the request data sent from the client and converts the data format of the request data into a specific data format. Then, the proxy sends the request data in the specific data format to the server, such that the server can process the request data from various clients. Thus, the server is compatible with different clients in data processing between the client and the server, improving the compatibility of the server for different clients.

What is claimed is:

1. A data processing method applied to a proxy capable of communicating with a client and a server, comprising:
receiving, by the proxy, request data in a first data format sent from the client associated with a computer game, wherein the first data format of the request data is supported by the client;
converting, by the proxy, the first data format of the request data into a specific data format associated with the server and not supported by the client, wherein the specific data format is a binary data format and used by the server; and
sending, by the proxy, the request data in the specific data format to the server, such that the server processes the request data in the specific data format.

2. The method according to claim 1, wherein receiving request data in a first data format sent from the client associated with a computer game further includes:
receiving the request data in a text data format sent from the client.

3. The method according to claim 2, wherein converting the first data format of the request data into a specific data format associated with the server and not supported by the client further includes:
decoding the request data in the text data format and converting the text data format into the binary data format.

4. The method according to claim 1, wherein sending the request data in the specific data format to a server further includes:
sending the request data in the binary data format to the server.

5. The method according to claim 3, wherein decoding the request data in the text data format further includes:
decoding the request data in the text data format by a base64 decoding scheme.

6. The method according to claim 1, further including:
receiving, by the proxy, feedback data in the specific data format sent from the server, wherein the specific data format is the binary data format;
converting, by the proxy, the specific data format of the feedback data into a data format that is supported by the client; and
sending, by the proxy, the feedback data in the converted data format to the client.

7. The method according to claim 6, wherein receiving feedback data in the specific data format sent from the server further includes:
receiving the feedback data in the binary format sent from the server.

8. The method according to claim 6, wherein converting the specific data format of the feedback data into a data format that is supported by the client further includes:
encoding the feedback data in the binary format and converting the binary data format of the feedback data to the text data format.

9. The method according to claim 6, wherein sending the feedback data in the converted data format to the client further includes:
sending the feedback data in the text data format to the client.

10. A data processing apparatus applied to a proxy capable of communicating with a client and a server, comprising:
a first receiving module configured to receive request data in a first data format sent from the client associated with a computer game, wherein the first data format of the request data is supported by the client;
a first data format conversion module configured to convert the first data format of the request data into a specific data format associated with the server and not supported by the client, wherein the specific data format is a binary data format and used by the server; and
a first sending module configured to send the request data in the specific data format to the server, such that the server processes the request data in the specific data format.

11. The apparatus according to claim 10, wherein the first receiving module further includes:
a first receiving unit configured to receive the request data in a text data format sent from the client.

12. The apparatus according to claim 11, wherein the first data format conversion module further includes:
a first data format conversion unit configured to decode the request data in the text data format and convert the text data format into the binary data format.

13. The apparatus according to claim 10, further including:
a second receiving module configured to receive feedback data in the specific data format sent from the server, wherein the specific data format is the binary data format;
a second data format conversion module configured to convert the specific data format of the feedback data into a data format that is supported by the client; and
a second sending module configured to send the feedback data in the converted data format to the client.

14. The apparatus according to claim 13, wherein the second receiving module further includes:
a second receiving unit configured to receive the feedback data in the binary data format sent from the server.

15. The apparatus according to claim 13, wherein the second data format conversion module further includes:
a second data format conversion unit configured to encode the feedback data in the binary data format and convert the binary data format of the feedback data into the text data format.

16. A data processing system, comprising:
a client configured to send request data to a proxy and receive feedback data in the converted data format sent from the proxy.
the proxy configured to:
receive the request data in a first data format sent from the client associated with a computer game, convert the first data format of the request data into a specific data format associated with the server and not supported by the client, and send the request data in the specific data format to a server; and
receive the feedback data in the specific data format sent from the server, convert the data format of the feedback data into a data format that is supported by the client and send the feedback data in the converted data format to the client; and
the server configured to:
receive the request data in the specific data format sent from the proxy;
process the request data in the specific data format; and
send the feedback data in the specific data format to the proxy.
